(19) United States
(12) Patent Application Publication
(10) Pub. No.: US 2025/0233948 A1
(43) Pub. Date: Jul. 17, 2025

(54) INSPECTING APPARATUS AND INSPECTING SYSTEM

(71) Applicant: CANON KABUSHIKI KAISHA, Tokyo (JP)

(72) Inventor: TAKUMI KIMURA, Chiba (JP)

(21) Appl. No.: 19/014,934

(22) Filed: Jan. 9, 2025

(30) Foreign Application Priority Data
Jan. 15, 2024 (JP) 2024-003740

(51) Int. Cl. H04N 1/00

(52) U.S. Cl. CPC H04N 1/00037; H04N 1/00005; H04N 1/00076; H04N 1/00084

(57) ABSTRACT

An inspecting apparatus includes a receiving interface configured to receive a scanned image generated by scanning a printed material generated by forming an image on a sheet using an image forming apparatus, and a controller configured to inspect the printed material based on the scanned image and a correct image registered in advance and instruct, in response to determining the printed material to be a defective sheet in the inspection on the printed material, the image forming apparatus to perform first recovery printing for reprinting starting from the image printed on the defective sheet. The controller inspects a subsequent sheet following the sheet determined to be a defective sheet through the inspection on the printed material. In a case where a result of the inspection performed on the subsequent sheet satisfies a predetermined condition, the controller issues an instruction to perform second recovery printing different from the first recovery printing.

### BACKGROUND

### Field of the Disclosure

The present disclosure relates to an inspecting apparatus and inspecting system.

### Description of the Related Art

Inspecting apparatuses that automatically perform inspections as post-processing for printing machines have been introduced, while conventional printed material inspection is performed manually. In such an inspecting apparatus, initially, reference image data is registered. Next, an image forming apparatus prints input image data on a sheet, and an inspection sensor installed in the inspecting apparatus reads the image printed on the sheet. The image data (scanned image) read by the inspection sensor is compared with the reference image data registered first to detect sheets (hereinafter, referred to as “defective sheets”) with smudges (printing defects) resulting from printing. Some image forming apparatuses of this type are equipped with a purge function to discharge defective sheets to a tray (hereinafter, referred to as “purge tray”) different from a tray for normal printed materials. There are also image forming apparatuses equipped with a recovery printing function to align the page order when discharging defective sheets into the purge tray. The recovery printing function here refers to a function that temporarily stops a printing process upon detecting a defective sheet, discharges the defective sheet and subsequent sheets (hereinafter, referred to as “in-apparatus remaining sheets”) following the defective sheet and remaining in the apparatus into the purge tray, and reprints starting from the defective sheet. In Japanese Patent Application Laid-Open No. 2021-30640, an in-apparatus remaining sheet, which is a sheet remaining on a conveying path at a time of detection of a defective sheet, is discharged into a tray in a case where the in-apparatus remaining sheet meets predetermined quality. In a case where each copy consists of a plurality of sheets, the remaining sheet on the conveying path is discharged as a normal printed material into the tray in a case where the sheet meets the predetermined quality and is the next in the output order after the last sheet discharged into the tray. The foregoing technology for reducing in-apparatus remaining sheets that would become waste sheets during recovery printing has been discussed.

### SUMMARY

According to embodiments of the present disclosure, an inspecting apparatus includes a receiving interface configured to receive a scanned image generated by scanning a printed material generated by forming an image on a sheet using an image forming apparatus, and a controller configured to inspect the printed material based on the scanned image and a correct image registered in advance and instruct, in response to determining the printed material to be a defective sheet in the inspection performed on the printed material, the image forming apparatus to perform first recovery printing for reprinting starting from the image printed on the defective sheet, wherein the controller inspects a subsequent sheet following the sheet determined to be a defective sheet through the inspection performed on the printed material, and wherein, in a case where a result of the inspection performed on the subsequent sheet satisfies a predetermined condition, the controller issues an instruction to perform second recovery printing different from the first recovery printing.

Further features of the present disclosure will become apparent from the following description of exemplary embodiments with reference to the attached drawings.

### BRIEF DESCRIPTION OF THE DRAWINGS

FIG. 1 is a diagram illustrating an example of an overall configuration of an inspection system according to an exemplary embodiment.

FIG. 2 is an example of an internal configuration diagram illustrating an image forming apparatus 100 according to an exemplary embodiment.

FIG. 3 is an example of a hardware configuration diagram illustrating the image forming apparatus 100 according to an exemplary embodiment.

FIGS. 4A and 4B are diagrams illustrating an example of a purge process according to an exemplary embodiment.

FIGS. 5A to 5C are diagrams illustrating an example of a second recovery printing process according to an exemplary embodiment.

FIG. 6 is an example of a flowchart illustrating a process during recovery printing according to a first exemplary embodiment.

FIG. 7 is an example of a flowchart illustrating a process during second recovery printing according to an exemplary embodiment.

FIG. 8 is an example of a flowchart illustrating a process during recovery printing according to a third exemplary embodiment.

FIGS. 9A to 9C are diagrams illustrating an example of a first recovery printing process according to an exemplary embodiment.

### DESCRIPTION OF THE EMBODIMENTS

Various exemplary embodiments of the present disclosure will be described below with reference to the accompanying drawings. It should be noted that the following exemplary embodiments are not intended to limit the scope of the disclosure. While the exemplary embodiments describe a plurality of features, not all of the plurality of features are always essential, and the plurality of features may be combined freely.

### Configuration of Entire System

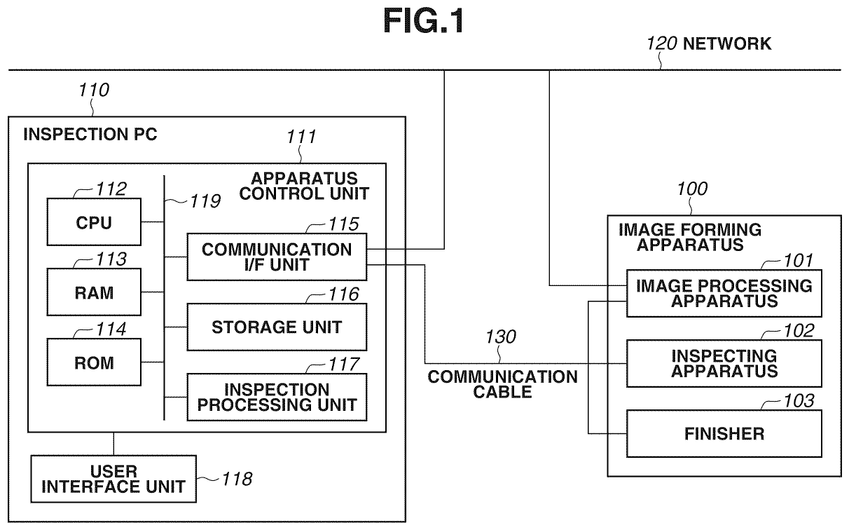

A first exemplary embodiment of the present disclosure will be described below. FIG. 1 is an overall configuration diagram illustrating an inspection system according to the present exemplary embodiment. In the inspection system according to the present exemplary embodiment, an image forming apparatus 100, an inspection personal computer (inspection PC) 110, a network 120, and a communication cable 130 are connected to communicate with each other.

The image forming apparatus 100 receives various types of input data and print job data and performs print output via the network 120. The image forming apparatus 100 includes an image processing apparatus 101, an inspecting apparatus 102, and a finisher 103, and the image processing apparatus 101, the inspecting apparatus 102, the finisher 103, and the inspection PC 110 are connected via the communication cable 130, which is an internal bus.

The image processing apparatus 101 performs image processing on various types of input data based on print settings and outputs the processed image as a printed material.

The inspecting apparatus 102 receives the printed material output from the image processing apparatus 101 and acquires image data for inspecting whether abnormal images are present in the received printed material. The abnormal images herein refer to those that degrade the quality of printed materials. Examples thereof include round- shaped abnormal images (spots) resulting from color materials adhering to unintended areas during printing, color fading resulting from insufficient adhesion of color materials to intended areas, and linear abnormal images (streaks). The acquired image data is transferred to the inspection PC 110, which will be described below, via the communication cable 130 and inspected for abnormal images in the printed material on the inspection PC 110, and the inspection result is acquired from the inspection PC 110.

The finisher 103 receives the output sheet inspected by the inspecting apparatus 102 and, based on the inspection result from the inspection PC 110, switches a sheet discharge destination and performs post-processing (such as bookbinding), as appropriate.

The image forming apparatus 100 connects to the inspection PC 110 via the communication cable 130 and communicates image data during inspection and inspection results. While inspection is performed by the inspection PC 110 according to the present exemplary embodiment, the present exemplary embodiment is not a limitation, and a configuration similar to an inline inspection machine, which performs image formation, inspection, post-processing, and sheet discharge consistently, may be employed. Details of the configuration of the image forming apparatus 100 according to the present exemplary embodiment will be described below.

The inspection PC 110 is a personal computer (PC) for inspecting images read from printed materials using the inspecting apparatus 102 and includes an apparatus control unit 111 and a user interface unit 118 (hereinafter, referred to as “UI unit”). Further, the apparatus control unit 111 includes a controller board, and a central processing unit (CPU) 112, a random access memory (RAM) 113, a read-only memory (ROM) 114, a communication interface (communication I/F) unit 115, a storage unit 116, and an inspection processing unit 117 are mounted on the apparatus control unit 111. These modules communicate with each other via an internal system bus 119. The inspection PC 110 may be configured to be built into the inspecting apparatus 102.

The CPU 112 reads a main program from the storage unit 116 based on an initial program in the storage unit 116 and stores the read main program in the RAM 113. The RAM 113 is used for storing programs and as a main memory for work. The ROM 114 is used to temporarily store data generated during the processing of a program. The communication I/F unit 115 is used to communicate via the network 120 or the communication cable 130. The storage unit 116 is used to store large-capacity data, such as programs, image data, and inspection jobs. In order to inspect whether abnormal images such as smudges or color fading are present in the image data acquired by the inspecting apparatus 102, the inspection processing unit 117 calculates difference values between a reference image stored as a correct image in the RAM 113 and an inspecting target scanned image. Next, the inspection processing unit 117 performs an inspection by comparing the calculated difference values with inspection thresholds (contrast and size) for each inspection item at each pixel. The inspection results are stored in the RAM 113. For example, information indicating whether abnormal images are present in the printed material and position information about detected abnormal images for displaying types (spot, streak) of the abnormal images on the UI unit 118 are stored. The inspection results are transmitted to the inspecting apparatus 102 and the finisher 103 via the communication cable 130.

The UI unit 118 is a device including, for example, a keyboard, a mouse, a display, and other input devices and configured to receive input of various setting values or designated values.

An overall system configuration including the inspecting apparatus according to the present exemplary embodiment has been described. While image data for inspection and inspection results are communicated via the communication cable 130 according to the present exemplary embodiment, any form that enables communication between the apparatuses may be employed. For example, image data for inspection and inspection results may be communicated via the network 120.

### Internal Configuration of Image Forming Apparatus 100

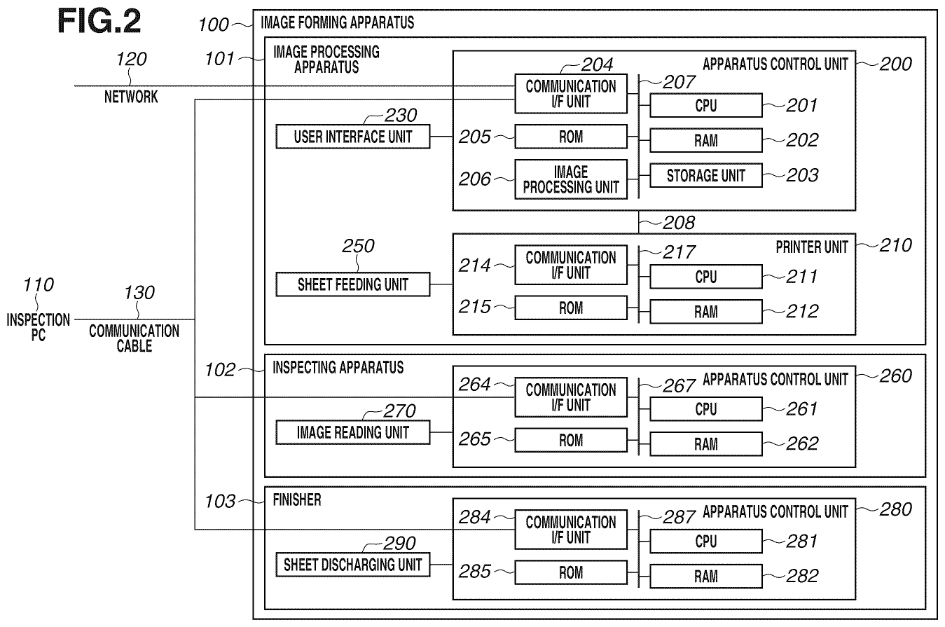

FIG. 2 is a diagram illustrating an internal configuration of the image forming apparatus 100 according to the present exemplary embodiment.

The image forming apparatus 100 includes the image processing apparatus 101, the inspecting apparatus 102, and the finisher 103.

Further, the image processing apparatus 101 includes an apparatus control unit 200, a printer unit 210, a UI unit 230, and a sheet feeding unit 250.

The apparatus control unit 200 receives images and documents from the network 120 and converts the received images and documents into print data. The apparatus control unit 200 includes a CPU 201, a RAM 202, a storage unit 203, a communication I/F unit 204, a ROM 205, an image processing unit 206, and an internal system bus 207. Roles of the foregoing devices are similar to those in the inspection PC 110, except for the image processing unit 206, so that descriptions of those having similar roles will be omitted.

The image processing unit 206 acquires Pate Description Language (PDL) data stored in the RAM 202 and performs image processing for converting the PDL data into print data. The image processing for converting PDL data into print data refers to, for example, performing Raster Image Processing (RIP) on the PDL data to convert the PDL data into multivalued bitmap data and performing known screen processing to convert the multivalued bitmap data into binary bitmap data. The binary bitmap data acquired by the image processing unit 206 is transmitted from the communication I/F unit 204 to the printer unit 210 via an internal system bus 208.

The printer unit 210 conveys a recording material from the sheet feeding unit 250, receives the binary bitmap data generated by the apparatus control unit 200, and forms an image on the recording material using color materials. At this time, instructions are issued to the printer unit 210 based on print settings designated by a user. For example, for print settings using coated sheet, a CPU 211 issues an instruction to print using a sheet feeding deck storing coated sheet in the sheet feeding unit 250. Various processes from receiving the PDL data to printing on the recording material are controlled by the apparatus control unit 200 and the printer unit 210, so that a full-color toner image is formed on the recording material. The printer unit 210 includes the CPU 211, a RAM 212, a communication I/F unit 214, a ROM 215, and an internal system bus 217. Roles of these devices are similar to those in the apparatus control unit 200, so that descriptions thereof will be omitted.

The UI unit 230 is a device includes, for example, a keyboard, a mouse, a display, and other input devices and configured to receive input of various setting values or designated values.

The sheet feeding unit 250 includes one or more cassettes in which recording materials to be printed are set and is a device for feeding a recording material from the cassette that corresponds to the recording material size designated in the print settings and conveying the fed recording material to the printer unit 210.

The inspecting apparatus 102 includes an apparatus control unit 260 and an image reading unit 270.

The image reading unit 270 is a device for reading the printed material conveyed from the printer unit 210 using a charge-coupled device (CCD) sensor and acquiring the read printed material as image data including red, green, and blue multivalued signals.

The apparatus control unit 260 performs control to transfer the image data acquired by the image reading unit 270 to the inspection PC 110 via the communication cable 130. Whether abnormal images are present in the printed material is inspected on the inspection PC 110 based on the transferred image data, and the inspection result is acquired from the inspection PC 110. The apparatus control unit 260 includes a CPU 261, a RAM 262, a communication I/F unit 264, a ROM 265, and an internal system bus 267. Roles of these devices are similar to those in the apparatus control unit 200, so that descriptions thereof will be omitted.

The finisher 103 includes an apparatus control unit 280 and a sheet discharging unit 290.

The apparatus control unit 280 determines a sheet discharge control to be implemented by the sheet discharging unit 290 based on print settings and the inspection result. The apparatus control unit 280 includes a CPU 281, a RAM 282, a communication I/F unit 284, a ROM 285, and an internal system bus 287. Roles of these devices are similar to those in the apparatus control unit 200, so that descriptions thereof will be omitted.

The sheet discharging unit 290 is a device for performing post-processing (such as bookbinding) on the printed material conveyed from the inspecting apparatus 102 based on the print settings and for switching the sheet discharge destination based on the inspection result.

For example, the sheet discharge destination may be switched based on whether abnormal images are present in the printed material.

In the case of switching the sheet discharge destination based on the inspection result, the finisher 103 discharges printed materials with no abnormal images to a normal sheet discharging tray and those with an abnormal image to another tray different from the normal sheet discharging tray, using the inspection result received from the inspection PC 110.

### Hardware Configuration of Image Forming Apparatus 100

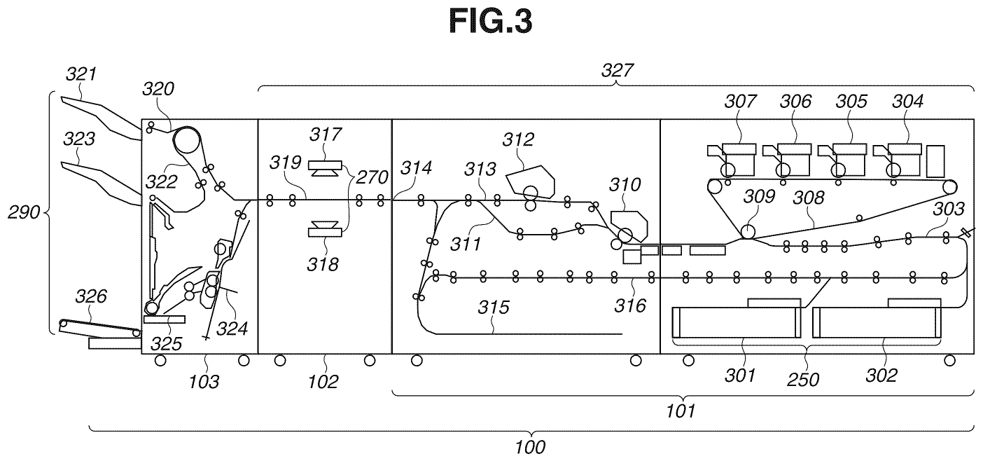

FIG. 3 is a sectional view illustrating an example of a hardware configuration of the image forming apparatus 100. An example of specific operations of the image forming apparatus 100 will be described below with reference to FIG. 3.

In the image processing apparatus 101, sheet feeding decks 301 and 302 store various recording materials. The uppermost recording material stored in the sheet feeding deck 301 or 302 is separated one sheet at a time and fed into a conveying path 303. Image forming stations 304 to 307 each include a photosensitive drum (photosensitive member) and form a toner image on the photosensitive drum using toner of a different color from each other. Specifically, the image forming station 304 to 307 form toner images using yellow (Y), magenta (M), cyan (C), and black (K) toners, respectively.

The toner images of the respective colors formed by the image forming stations 304 to 307 are sequentially transferred (primary transfer) onto an intermediate transfer belt 308 and layered. The transferred toner images on the intermediate transfer belt 308 are conveyed to a secondary transfer position 309 by rotation of the intermediate transfer belt 308. At the secondary transfer position 309, the toner images are transferred (secondary transfer) from the intermediate transfer belt 308 onto the recording material conveyed through the conveying path 303. The recording material after the secondary transfer is conveyed to a fixing unit 310. The fixing unit 310 includes a pressing roller and a heating roller.

A fixing process of fixing the toner images to the recording material is performed by applying heat and pressure to the recording material while the recording material passes between the rollers. After passing through the fixing unit 310, the recording material is conveyed through a conveying path 311 to a connection point 314 between the image processing apparatus 101 and the inspecting apparatus 102. A color image is formed (printed) on the recording material as described above.

In a case where further fixing processing is to be performed based on the type of the recording material, the recording material after passing through the fixing unit 310 is guided to a conveying path 313 to which a fixing unit 312 is disposed. The fixing unit 312 performs further fixing processing on the recording material conveyed through the conveying path 313. The recording material after passing through the fixing unit 312 is conveyed to the connection point 314. In a case where an operation mode in which two-sided printing is to be performed is set, after an image is printed on a first surface of the recording material, the recording material conveyed through the conveying path 311 or the conveying path 313 is guided to a reversing path 315. The recording material reversed in the reversing path 315 is guided to a two-sided conveying path 316 and conveyed to the secondary transfer position 309. Thus, the toner images are transferred onto a second surface opposite the first surface of the recording material at the secondary transfer position 309. Thereafter, the recording material passes through the fixing unit 310 (and the fixing unit 312), thus completing color image formation on the second surface of the recording material.

After image formation (printing) by the image processing apparatus 101 is completed, the printed material conveyed to the connection point 314 is conveyed into the inspecting apparatus 102.

The inspecting apparatus 102 includes image reading units 317 and 318 each including a contact image sensor (CIS) and disposed on a conveying path 319 through which the printed material from the image processing apparatus 101 is conveyed. The image reading units 317 and 318 are positioned to face each other across the conveying path 319. The image reading units 317 and 318 are respectively configured to read an upper surface (first surface) and a lower surface (second surface) of the printed material. The image reading units 317 and 318 may include a CCD sensor or a line scan camera instead of a CIS.

The inspecting apparatus 102 performs a reading process for reading the printed material conveyed through the conveying path 319 using the image reading units 317 and 318. After passing through the inspecting apparatus 102, the printed material is sequentially conveyed to the finisher 103.

The finisher 103 performs finishing functions designated by the user on the printed material conveyed from the inspecting apparatus 102. According to the present exemplary embodiment, the finisher 103 includes finishing functions such as the bookbinding function and the function of switching the sheet discharge destination based on an inspection result. In the case of switching the sheet discharge destination based on an inspection result, the finisher 103 discharges the printed material with no abnormal images as a deliverable into a normal tray 321 through a sheet conveying path 320 using the inspection result received from the inspection PC 110. The printed material with an abnormal image is discharged into a purge tray 323 (sheet discharging tray) through a sheet conveying path 322. In a case where bookbinding is designated, a processing unit 324 performs a stapling process in the center of the sheet, and thereafter the sheet is folded in half and then output to a bookbinding tray 326 through a sheet conveying path 325.

A conveying path 327 includes the conveying paths 303, 311, and 313 in the image processing apparatus 101 and the conveying path 319 in the inspecting apparatus 102.

The image forming apparatus 100 according to the present exemplary embodiment has been described. The present exemplary embodiment is not a limitation, and any configuration capable of printing print data and reading an image to inspect whether abnormal images are present in the printed material may be employed.

### Recovery Printing Function

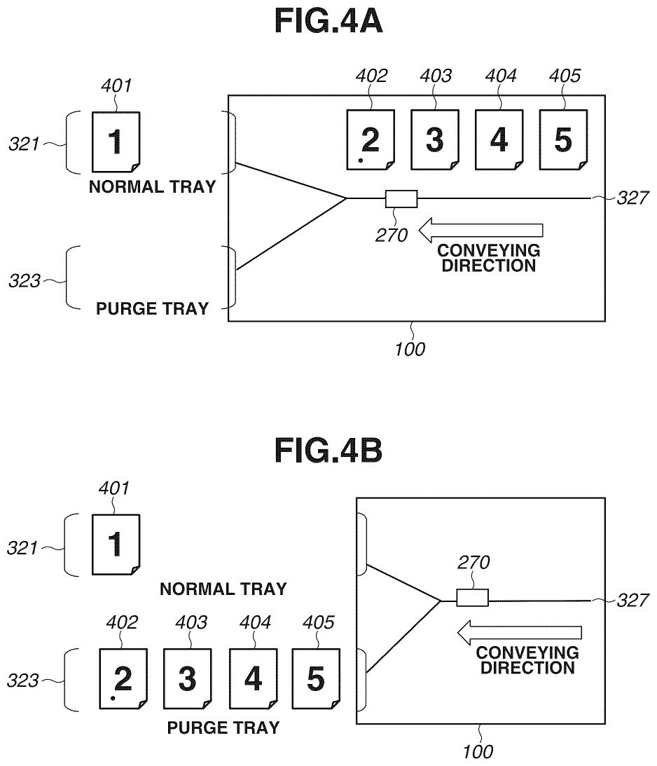

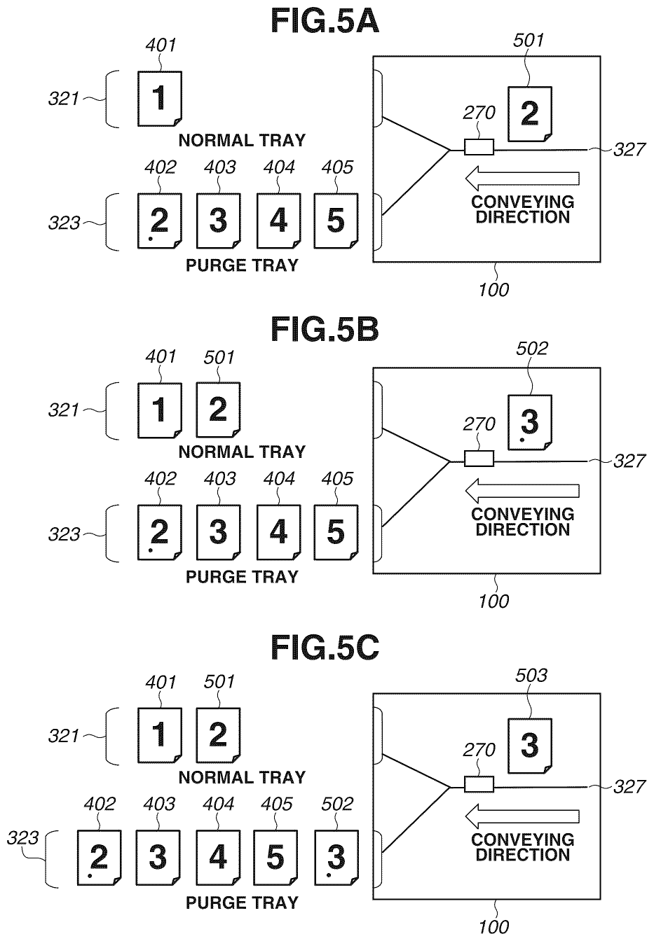

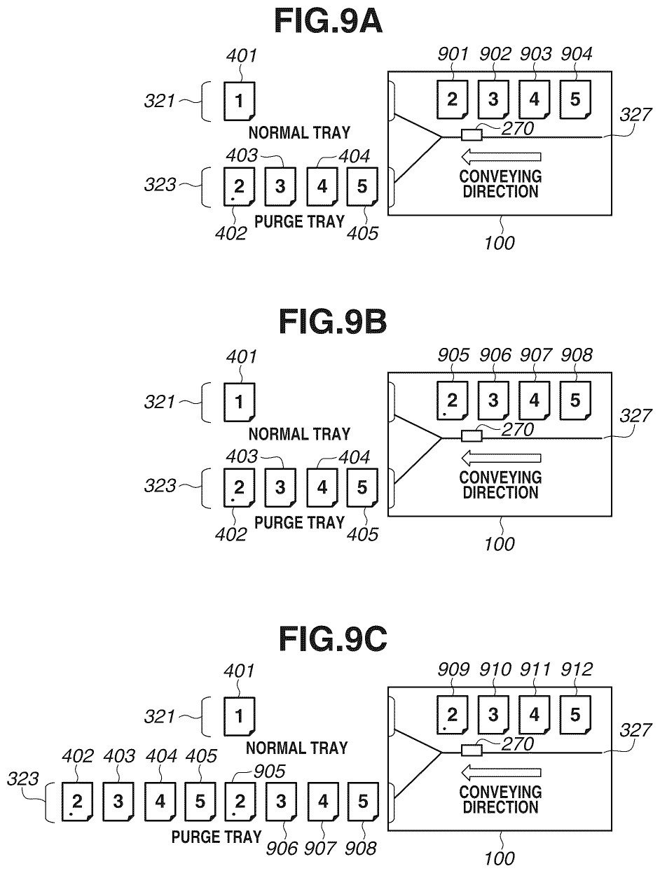

A purge process during recovery printing in a case where a defective sheet is detected during an inspection on the printed material will be described below with reference to FIGS. 4A and 4B. Recovery printing that has already existed (hereinafter, referred to as “first recovery printing”) after the purge process is completed will be described below with reference to FIGS. 9A to 9C, and recovery printing that does not generate in-apparatus remaining sheets (hereinafter, referred to as “second recovery printing”) after the purge process is completed will be described below with reference to FIGS. 5A to 5C. An example of a case of performing a job of printing a plurality of copies each including five or more pages will be described below with reference to FIGS. 4A, 4B, 9A to 9C, and 5A to 5C. While a case of performing one-sided printing is described as an example, a similar process applies to cases using two-sided printing.

FIG. 4A illustrates states of printed materials in a case where a defective sheet 402 is detected during inspecting of the printed materials. A printed material 401 is in the normal tray 321 after being inspected and discharged, and printed materials 402 to 405 are conveyed along the conveying path 327 in this order. After the defective sheet 402 is detected, the printing is temporarily stopped, and the defective sheet 402 is discharged into the purge tray 323 together with the printed materials 403 to 405 as in-apparatus remaining sheets. The in-apparatus remaining sheets refer to the printed materials present on the conveying path 327 in the image forming apparatus 100 at the time of the occurrence of the defective sheet 402.

FIG. 4B illustrates states of the printed materials after the defective sheet 402 is detected during inspecting of the printed materials and the purge process on the defective sheet 402 and the in-apparatus remaining sheets 403 to 405 is completed. The defective sheet 402 and the in-apparatus remaining sheets 403 to 405 are discharged into the purge tray 323 different from the normal tray 321, and no printed materials are present on the conveying path 327. Thereafter, reprinting is performed starting from the image printed on the defective sheet 402.

A case of performing first recovery printing after the purge process described in conjunction with FIGS. 4A and 4B is completed will be described below with reference to FIGS. 9A to 9C.

FIG. 9A illustrates the first recovery printing after the defective sheet 402 is detected during inspecting of the printed materials and the purge process on the defective sheet 402 and the in-apparatus remaining sheets 403 to 405 is completed. Normal printing is resumed starting from the page on which the defective sheet 402 is detected, and the same pages as the page on which the defective sheet 402 is detected and the pages on the in-apparatus remaining sheets 403 to 405 following the defective sheet 402 are reprinted on printed materials 901 to 904. In a case where the printed materials 901 to 904 are inspected and no printing defects are detected, the printed materials 901 to 904 are discharged as deliverables into the normal tray 321, so that the page order is aligned while the defective sheet 402 is removed.

FIG. 9B illustrates the first recovery printing after the defective sheet 402 is detected and the purge process on the defective sheet 402 and the in-apparatus remaining sheets 403 to 405 is completed in a case where a printing defect occurs periodically every four sheets. Printing at a normal printing speed is resumed starting from the page on which the defective sheet 402 is detected. The same pages as the page on which the defective sheet 402 is detected and the pages on the in-apparatus remaining sheets 403 to 405 following the defective sheet 402 are reprinted on printed materials 905 to 908, and a printing defect occurs on the printed material 905. At the stage of inspecting the printed material 905, the printed material 905 is discharged as a defective sheet 905 and the printed materials 906 to 908 are discharged as in-apparatus remaining sheets 906 to 908 into the purge tray 323 as in FIG. 9A, and reprinting is performed starting from the same page as that on the defective sheet 905. The same operation applies to cases where consecutive printing defects occur not only on the defective sheet 402 and 905 but also on the remaining sheets 403 to 405 and 906 to 908.

FIG. 9C illustrates the first recovery printing after the defective sheet 905 is detected and the purge process on the defective sheet 905 and the in-apparatus remaining sheets 906 to 908 is completed during the first recovery printing illustrated in FIG. 9B. Normal printing is resumed starting from the page on which the defective sheet 905 is detected, the same pages as the page on which the defective sheet 905 and the pages on the in-apparatus remaining sheets 906 to 908 following the defective sheet 905 are reprinted on printed materials 909 to 912, and a printing defect occurs on the printed material 909. At the stage of inspecting the printed material 909, the printed material 909 is discharged as a defective sheet 909 and the printed materials 910 to 912 are discharged as in-apparatus remaining sheets 910 to 912 into the purge tray 323 as in FIG. 9A, and reprinting is performed starting from the same page as that on the defective sheet 909.

In cases where an accidental defect occurs as described above, recovery processing is possible in a short time as in FIG. 9A. Meanwhile, in a case where a defect occurs periodically every four sheets, the state illustrated in FIG. 9C is repeated until the printing is stopped, generating a large amount of waste sheets.

Here, enable/disable the function to stop printing in a case where a defective sheet occurs consecutively for a predetermined number of times may be set, separately from a recovery printing function. For example, in a case where the function to stop printing in a case where a defective sheet occurs consecutively five times (without including the in-apparatus remaining sheets in the consecutive count) is enabled, recovery printing is repeated four times, resulting in a large amount of waste sheets.

FIGS. 9A to 9C illustrate the operation in the first recovery printing in a case where a defective sheet is detected during inspecting of the printed materials, which leads to a large amount of waste sheets in a case where a non-accidental defect occurs. Thus, the second recovery printing, in which waste sheets are reduced by performing recovery printing using a method that does not generate in-apparatus remaining sheets during recovery printing, will be described below with reference to FIGS. 5A to 5C, starting from the state illustrated in FIGS. 4A and 4B after the purge process is completed.

FIG. 5A illustrates a recovery process immediately after the defective sheet 402 is detected during inspecting of the printed materials and the purge process on the defective sheet 402 and the in-apparatus remaining sheets 403 to 405 is completed.

Reprinting is performed on a printed material 501 starting from the image printed on the page on which the defective sheet 402 is detected. On the conveying path 327, no image formation occurs except for the printed material 501, and after the inspecting of the printed material 501 is completed, the next recording material is conveyed along the conveying path 327, and printing is performed.

FIG. 5B illustrates an operation in a case where the previous inspection result during the second recovery printing is normal. In a case where the inspection result of the printed material 501 is normal in FIG. 5A, the printed material 501 is discharged into the normal tray 321, and the page following the printed material 501 is printed on a printed material 502. On the conveying path 327, no image formation occurs except for the printed material 502, and after the inspecting of the printed material 502 is completed, the next printed material is conveyed along the conveying path 327, and printing is performed.

FIG. 5C illustrates an operation in a case where the previous inspection result during the recovery printing process is abnormal. In a case where the inspection result of the printed material 502 is abnormal in FIG. 5B, the printed material 502 is discharged into the purge tray 323, and the same page as that on the printed material 502 is printed on a printed material 503. On the conveying path 327, no image formation is except for the printed material 503, and after the inspecting of the printed material 503 is completed, the next printed material is conveyed along the conveying path 327, and printing is performed.

After reprinting the defective sheet 402 and the in-apparatus remaining sheets 403 to 405 without printing defects is completed, the second recovery printing is terminated, and normal printing is resumed starting from the page following the last page discharged into the normal tray 321. The second recovery printing process may be terminated based on a predetermined condition and switched to normal printing. For example, the recovery printing process may be terminated in a case where the recovery printing process for the number of pages preset by the user is completed. In this case, normal printing is resumed starting also from the page following the last page discharged into the normal tray 321.

Thus, image formation is performed with the number of printed materials on the conveying path 327 during recovery printing being limited to one, so that occurrence of in-apparatus remaining sheets is prevented even in cases where non-accidental defective sheets occur. For example, in a case where the function to stop printing in a case where a defective sheet occurs consecutively five times is enabled, only five sheets that are the in-apparatus remaining sheets at the time of detecting the first defective sheet and the defective sheet become waste sheets, making it possible to prevent the occurrence of a large amount of waste sheets.

### Recovery Printing Processing

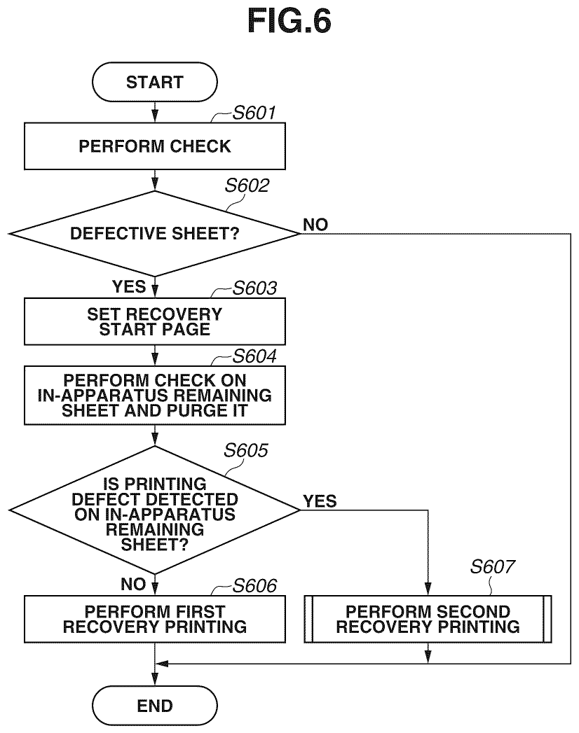

FIG. 6 is a flowchart illustrating operations in a case where the CPU 112 of the inspection PC 110 inspects printed materials, detects a defective sheet, and performs the recovery printing process. Performing the process makes it possible to reduce waste sheets in cases where non-accidental printing defects occur.

Each process in FIG. 6 is realized by the CPU 112 expanding the program code stored in the ROM 114 into the RAM 113 and executing the program code expanded in the RAM 113.

In step S601, the CPU 112 detects a conveyed printed material, scans the detected printed material using the image reading unit 270, and stores the scanned image in the RAM 113. The scanned image of the printed material is compared with the reference image registered and stored in advance in the RAM 113 as a correct image for inspecting, and difference values between the scanned image and the reference image are calculated. Whether printing defects are present on the scanned image is inspected based on the calculated difference values.

In step S602, the CPU 112 determines whether the printed material is a defective sheet based on an inspection result for the printed material in step S601. In a case where the printed material is a defective sheet (YES in step S602), the processing proceeds to step S603. In a case where the printed material is not a defective sheet (NO in step S602), the processing in the flowchart is terminated.

In step S603, the CPU 112 sets the page determined to be a defective sheet based on the inspection result for the printed material in step S601 as a recovery start page. Information for temporarily stopping the printing is transmitted to the apparatus control unit 200 via the communication I/F unit 115, and information for discharging the defective sheet into the purge tray 323 is transmitted to the apparatus control unit 280 via the communication I/F unit 115.

The CPU 201 that has received the information via the communication I/F unit 204 instructs the printer unit 210 to temporarily stop printing. The image forming apparatus 100 temporarily stops the printing operation as the printer unit 210 is instructed to temporarily stop printing.

The CPU 281 that has received the information via the communication I/F unit 284 discharges the defective sheet into the purge tray 323.

In step S604, the CPU 112 inspects in-apparatus remaining sheets following the defective sheet as in step S601 and transmits information for discharging the in-apparatus remaining sheets into the purge tray 323 to the apparatus control unit 280 via the communication I/F unit 115.

The CPU 281 that has received the information via the communication I/F unit 284 discharges the in-apparatus remaining sheets into the purge tray 323. The in-apparatus remaining sheets are discharged into the purge tray 323 in a case where a printing defect is detected on the in-apparatus remaining sheets and also in a case where no printing defects are detected on the in-apparatus remaining sheets. This operation is performed to align the page order of the printed materials discharged into the normal tray 321. The same does not apply to cases of jobs in which a single copy includes a single image. In step S604, control may be performed to discharge each in-apparatus remaining sheet into the normal tray 321 or the purge tray 323 based on the inspection result of the in-apparatus remaining sheet.

In step S605, the CPU 112 determines whether a printing defect is present on the in-apparatus remaining sheets based on the inspection results of the in-apparatus remaining sheets in step S604. In a case where no printing defect is present on any of the in-apparatus remaining sheets (NO in step S605), the processing proceeds to step S606. In a case where a printing defect is present on an in-apparatus remaining sheet (YES in step S605), the processing proceeds to step S607.

In step S606, the CPU 112 transmits information for resuming printing (first recovery printing) starting from the recovery start page set in step S603 to the apparatus control unit 200 via the communication I/F unit 115, and the processing in the flowchart is terminated.

The CPU 201 that has received the information via the communication I/F unit 204 instructs the printer unit 210 to resume printing starting from the recovery start page. The image forming apparatus 100 resumes the printing operation in response to the printer unit 210 being instructed to reprint starting from the recovery start page.

In step S607, the CPU 112 transmits information for performing the second recovery printing to the apparatus control unit 200 via the communication I/F unit 115, and the process in the flowchart is terminated. Details of step S607 according to the present exemplary embodiment will be described below.

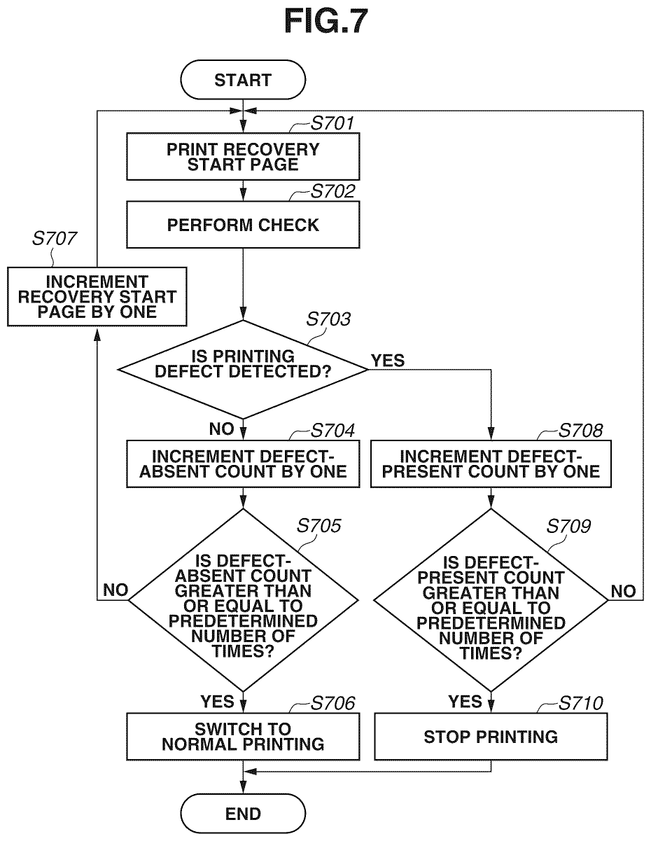

Next, the second recovery printing process in step S607 will be described below with reference to a flowchart in FIG. 7.

Each process in FIG. 7 is realized by the CPU 112 expanding the program code stored in the ROM 114 into the RAM 113 and executing the program code expanded in the RAM 113.

In step S701, the CPU 112 transmits information for printing one recovery start page set in step S603 or in step S707 described below to the apparatus control unit 200 via the communication I/F unit 115. While the present exemplary embodiment describes printing one page, the number of pages may be any specified number of pages less than that for the normal printing speed, such as two or three. In a case where no recovery start pages are present, information for terminating the printing is transmitted.

The CPU 201 that has received the information for printing one recovery start page from the CPU 112 via the communication I/F unit 204 instructs the printer unit 210 to print one recovery start page. The image forming apparatus 100 resumes the printing operation as the printer unit 210 is instructed to print one recovery start page. The CPU 201 that has received the information for terminating printing from the CPU 112 via the communication I/F unit 204 instructs the printer unit 210 to terminate printing. The image forming apparatus 100 terminates the printing operation in response to the printer unit 210 having been instructed to terminate printing.

In step S702, as in step S601, the CPU 112 inspects the recovery start page printed in step S701.

In step S703, the CPU 112 determines whether a printing defect is present on the recovery start page based on the inspection result of the recovery start page in step S702. In a case where no printing defect is present on the recovery start page (NO in step S703), the processing proceeds to step S704. In a case where a printing defect is present on the recovery start page (YES in step S703), the processing proceeds to step S708.

In step S704, the CPU 112 increments the count of cases where no printing defects are present on the recovery start page in the second recovery printing process. The count may be incremented only in a case where no printing defects are present consecutively.

In step S705, the CPU 112 determines whether the count of cases where no printing defects are present on the recovery start page is greater than or equal to a predetermined number of times. In a case where the count of cases where no printing defects are present on the recovery start page is greater than or equal to the predetermined number of times (YES in step S705), the processing proceeds to step S706. In a case where the count of cases where no printing defects are present on the recovery start page is less than the predetermined number of times (NO in step S705), the processing proceeds to step S707. The predetermined number of times can be preset by the user.

In step S706, the CPU 112 transmits information for resuming printing at the normal speed starting from the page following the recovery start page set in step S603 or in step S707 described below to the apparatus control unit 200 via the communication I/F unit 115. After the information is transmitted, the process in the flowchart is terminated. In cases where the recovery start page is the last page of the copy, information for resuming printing starting from the first page of the next copy is transmitted. In a case where there is no page following the recovery start page, information for terminating printing is transmitted.

The CPU 201 that has received the information for resuming printing from the CPU 112 via the communication I/F unit 204 instructs the printer unit 210 to print starting from the page following the recovery start page. The image forming apparatus 100 resumes the printing operation as the printer unit 210 is instructed to print starting from the page following the recovery start page. The CPU 201 that has received the information for terminating printing from the CPU 112 via the communication I/F unit 204 instructs the printer unit 210 to terminate printing. The image forming apparatus 100 terminates the printing operation as the printer unit 210 is instructed to terminate printing.

In step S707, the CPU 112 increments the recovery start page, and the processing returns to step S701. In a case where the recovery start page prior to the increment is the last page of the copy, the first page of the next copy is set to the recovery start page as a result of the increment. In a case where there is no page following the recovery start page, the absence of the recovery start page is set.

In step S708, the CPU 112 increments the count of cases where a print defect is present on the recovery start page in the second recovery printing process. The count may be incremented only In a case where a printing defect is present consecutively. Further, the CPU 112 transmits information for discharging the defective sheet into the purge tray 323 based on the inspection result of the printed material in step S702 to the apparatus control unit 280 via the communication I/F unit 115.

The CPU 281 that has received the information via the communication I/F unit 284 discharges the defective sheet into the purge tray 323.

In step S709, the CPU 112 determines whether the count of cases where a print defect is present on the recovery start page is greater than or equal to a predetermined number of times. In a case where the count of cases where a print defect is present on the recovery start page is greater than or equal to the predetermined number of times (YES in step S709), the processing proceeds to step S710. In a case where the count of cases where no printing defects are present on the recovery start page is less than the predetermined number of times (NO in step S709), the processing returns to step S701. The predetermined number of times can be preset by the user.

In step S710, the CPU 112 transmits information for terminating printing to the apparatus control unit 200 via the communication I/F unit 115, and the process in the flowchart is terminated.

The CPU 201 that has received the information via the communication I/F unit 204 instructs the printer unit 210 to terminate printing. The image forming apparatus 100 terminates the printing operation as the printer unit 210 is instructed to terminate printing.

As described above, inspecting of a printed material is started, and in a case where a defective sheet occurs, in-apparatus remaining sheets following the defective sheet are inspected, and the recovery printing operation is changed depending on the inspection results of the in-apparatus remaining sheets. This is because, in the cases where no printing defects are present on the in-apparatus remaining sheets, there is a high probability that the printing defect is accidental. Conversely, in the cases where a printing defect is present on the in-apparatus remaining sheets, there is a high probability that the printing defect is not accidental. Thus, in a case where no printing defects are present on the in-apparatus remaining sheets, the first recovery printing is performed, whereby recovery printing is achieved in a short time. In a case where a printing defect is present on the in-apparatus remaining sheets, the second recovery printing is performed, whereby recovery printing is performed for each sheet individually. Thus, even in a case where a defective sheet occurs during recovery printing, no in-apparatus remaining sheets occur following the defective sheet. This makes it possible to reduce waste sheets. While the second recovery printing is performed to print one sheet at a time according to the present exemplary embodiment, a preset number of sheets may be printed at a time. As an example, a case where the preset specified number of sheets is set to two will be described below. In step S703, in a case where no printing defects are detected on either of the two printed sheets, the processing proceeds to step S704, and the defect-absent count is incremented, or the count is increased by two sheets, which is the specified number of sheets. In step S706, printing is switched to normal printing starting from the page that follows the increase of the recovery start page count by two sheets, corresponding to the specified number of sheets. In step S707, the recovery start page count is increased by two sheets, corresponding to the specified number of sheets. In a case where a printing defect is detected on one or both of the two printed sheets in step S703, the processing proceeds to step S708, and the defect-present count is incremented, or the count is increased by the number of sheets on which the printing defect is detected. In step S708, the printed materials until the first printing defect is detected on the two sheets, which is the specified number of sheets, may be discharged into the normal tray 321, and the printed materials after the printing defect is detected may be discharged into the purge tray 323. In a case where a process in which the printed materials until the first printing defect is detected on the specified number of sheets are discharged into the normal tray 321 is performed in step S708, step S711 in which the recovery start page is set is added between steps S709 and S701. In a case where step S711 is added and a printing defect is detected on the first one of the two sheets, corresponding to the specified number of sheets, the first sheet is set to the recovery start page. In a case where the first sheet is normal and a printing defect is detected on the second sheet, the second sheet is set to the recovery start page. Specifically, a page on which a printing defect is first detected among the specified number of printed sheets is set to the recovery start page. Printing the specified number of sheets at a time as described above makes it possible to enhance time efficiency, compared to the cases of printing one sheet at a time.

### Recovery Printing Process

The first exemplary embodiment describes a method in which, in a case where a defective sheet occurs, in-apparatus remaining sheets following the defective sheet are inspected, and the recovery printing operation is changed depending on the inspection results of the in-apparatus remaining sheet, thus reducing waste sheets in instances of non-accidental printing defects. Next, a second exemplary embodiment will be described below with reference to FIG. 6. In the second exemplary embodiment, a description will be provided of a method for more accurately determining whether the printing defect has occurred accidentally, thus shortening the time for recovery printing. This reduces waste sheets.

Aspects according to the present exemplary embodiment that differ from those according to the first exemplary embodiment will be described below. Aspects not described in detail below are similar to those in the first exemplary embodiment.

In step S601, the CPU 112 detects a conveyed printed material, scans the detected printed material using the image reading unit 270, and stores the scanned image in the RAM 113 of the inspection PC 110.

The scanned image of the printed material is compared with a reference image stored in advance in the RAM 113 as a correct image for inspecting, and difference values between the scanned image and the reference image are calculated. Whether printing defects are present on the scanned image is inspected based on the calculated difference values. Here, difference feature extraction is performed on the in-apparatus remaining sheets on which a printing defect is detected. Examples of difference feature information that can be acquired through the extraction process include color material information, contrast information, size information, shape information, coordinate information, and periodic information. The color material information here refers to information indicating which of the colors yellow, magenta, cyan, and black contains the occurrence. The contrast information refers to information expressing the contrast in defect density of defective areas of the printing defect as a positive or negative value indicating whether the difference is toward a darker direction (positive direction) or a lighter direction (negative direction). The size information refers to information such as width (size in main scanning direction) and height (size in sub-scanning direction) information about the defect. The shape information refers to information such as spot shape, vertical streak shape, or horizontal streak shape. The coordinate information refers to information indicating a position in a direction perpendicular to the conveying direction of the printed material in the image processing apparatus 101. The periodic information refers to information indicating that defects with similar features occur periodically with respect to the conveying direction of the printed material in the image processing apparatus 101.

The operations in steps S602 to S604 illustrated in FIG. 6 are similar to those according to the present exemplary embodiment, so that descriptions thereof will be omitted.

In step S605, the CPU 112 determines whether printing defects are present on the in-apparatus remaining sheets based on the inspection results of the in-apparatus remaining sheets in step S604. In a case where no printing defects are present on the in-apparatus remaining sheet (NO in step S605), the processing proceeds to step S608 (not illustrated), which is added between steps S605 and S607 according to the present exemplary embodiment.

In step S608, the CPU 112 determines whether a predetermined condition is satisfied, based on the inspection results of the in-apparatus remaining sheets in step S604. In a case where the predetermined condition is satisfied (YES in step S608), the processing proceeds to step S607. In a case where the predetermined condition is not satisfied (NO in step S608), the processing proceeds to step S606.

The predetermined condition herein includes, for example, the following conditions.
(1) The proportion of defective sheets in the in-apparatus remaining sheets is greater than or equal to a predetermined proportion (first condition).
(2) The number of times a defective sheet occurs consecutively in the in-apparatus remaining sheets, including the sheet detected as a defective sheet during the inspection of the printed material in step S601, is greater than or equal to a predetermined number of times (second condition).
(3) The number of times a printing defect of similar color occurs in the in-apparatus remaining sheets, including the sheet detected as a defective sheet during the inspection of the printed material in step S601, is greater than or equal to a predetermined number of times (third condition).
(4) The number of times a printing defect of similar shape occurs in the in-apparatus remaining sheets, including the sheet detected as a defective sheet during the inspection of the printed material in step S601, is greater than or equal to a predetermined number of times (fourth condition).
(5) The number of times a printing defect of similar size occurs in the in-apparatus remaining sheets, including the sheet detected as a defective sheet during the inspection of the printed material in step S601, is greater than or equal to a predetermined number of times (fifth condition).
(6) The number of times a printing defect of similar density occurs in the in-apparatus remaining sheets, including the sheet detected as a defective sheet during the inspection of the printed material in step S601, is greater than or equal to a predetermined number of times (sixth condition).
(7) The number of times a printing defect occurs at nearly the same position in the main scanning direction in the in-apparatus remaining sheets, including the sheet detected as a defective sheet during the inspection of the printed material in step S601, is greater than or equal to a predetermined number of times (seventh condition).
(8) A periodic printing defect occurs in the in-apparatus remaining sheets, including the sheet detected as a defective sheet during the inspection of the printed material in step S601 (eighth condition).

The predetermined condition may be one condition selected from the first to eighth conditions by the user or an AND or OR condition based on a plurality of conditions. The predetermined proportion and the number of times in the first to seventh conditions can be set by the user. While the present exemplary embodiment describes the CPU 112 as the determining entity in step S608, this is not a limitation. For example, the CPU 112 may notify the apparatus control unit 200 of the inspection result via the communication I/F unit 115, and the CPU 201 of the apparatus control unit 200 may perform the determination.

The operations in steps S606 to S607 illustrated in FIG. 6 are similar to those according to the present exemplary embodiment, so that descriptions thereof will be omitted.

The color of the printing defect in the condition (3) described as an example of the predetermined condition may be determined using a read image that has a complementary color relationship to the print color of the printer. The shape of the printing defect in the condition (4) described as an example of the predetermined condition may be determined using a known centroid, bounding rectangle (bounding box), principal axis, perimeter, or circularity. Further, the periodic defect in condition (8) described as an example of the predetermined condition may be determined using a known Fast Fourier Transform, Euclidean distance, or 4-neighbor distance (city block distance). Other than those described above, 8-neighbor distance (chess board distance) or vector difference between defect centroids may be used in the determination.

By more accurately determining whether the printing defect has occurred accidentally, it becomes possible to shorten the time for recovery printing, thus reducing waste sheets.

### Recovery Printing Flow

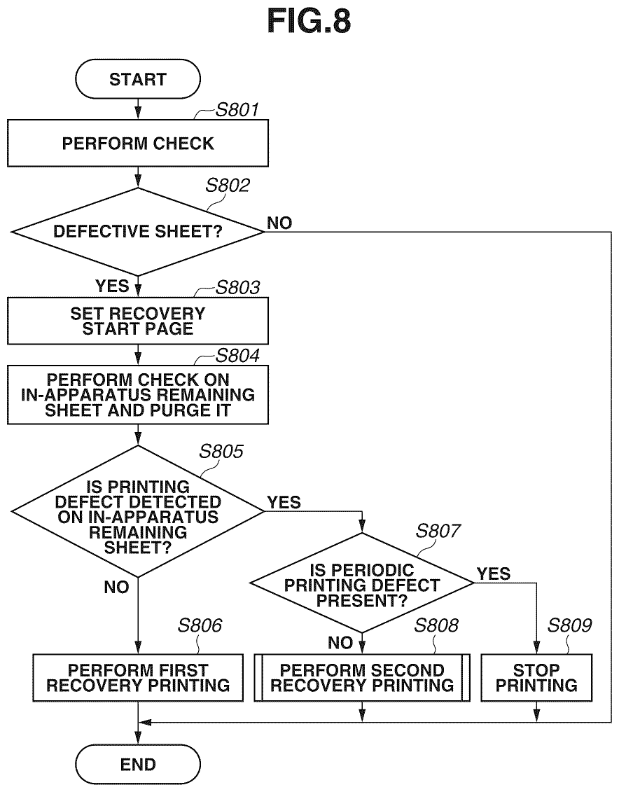

A third exemplary embodiment of the present disclosure will be described below. The second exemplary embodiment describes a method for more accurately determining whether the printing defect has occurred accidentally, thereby shortening the time for recovery printing and reducing waste sheets. Next, in the present exemplary embodiment, a method for reducing waste sheets in a case where there is a significantly high probability that a printing defect that has occurred is not accidental will be described below with reference to FIG. 8.

Aspects according to the present exemplary embodiment that differ from those according to the first exemplary embodiment will be described below. Aspects not described in detail below are similar to those in the first exemplary embodiment.

The operation in step S801 is similar to that in step S601 according to the second exemplary embodiment, so that descriptions thereof will be omitted.

The operations in steps S802 to S804 are similar to those in steps S602 to S604 illustrated in FIG. 6, so that descriptions thereof will be omitted.

In step S805, the CPU 112 determines whether printing defects are present on the in-apparatus remaining sheets based on the inspection results on the in-apparatus remaining sheets in step S804. In a case where no printing defects are present on the in-apparatus remaining sheet (NO in step S805), the processing proceeds to step S806. In a case where a printing defect is present on the in-apparatus remaining sheet (YES in step S805), the processing proceeds to step S807.

The operation in step S806 is similar to that in step S606 illustrated in FIG. 6, so that descriptions thereof will be omitted.

In step S807, the CPU 112 determines whether periodic printing defects are present on the in-apparatus remaining sheet based on results of inspection performed on the in-apparatus remaining sheets in step S804. In a case where no periodic printing defects are present on the in-apparatus remaining sheet (NO in step S807), the processing proceeds to step S808. In a case where a periodic printing defect is present on the in-apparatus remaining sheet (YES in step S807), the processing proceeds to step S809.

The operation in step S808 is similar to that in step S607 illustrated in FIG. 6, so that descriptions thereof will be omitted.

In step S809, the CPU 112 transmits information for terminating printing to the apparatus control unit 200 via the communication I/F unit 115, and the processing in the flowchart is terminated.

The CPU 201 that has received the information via the communication I/F unit 204 instructs the printer unit 210 to terminate printing. The image forming apparatus 100 terminates the printing operation as the printer unit 210 is instructed to terminate printing.

As described above, in a case where there is a significantly high probability that a printing defect that has occurred is not accidental, printing is terminated without performing recovery printing, thus preventing the occurrence of waste sheets. This is because, in a case where there is a significantly high probability that a printing defect that has occurred is not accidental, there is also a significantly high probability that printing defects will occur during recovery printing, resulting in waste sheets.

While the second recovery printing is performed in a case where a defect is not periodic in step S807 according to the present exemplary embodiment, the second recovery printing may be performed in a case where the defect is not periodic and the predetermined condition in step S605 according to the second exemplary embodiment is satisfied. In this case, the first recovery printing may be performed in a case where the defect is not periodic and predetermined condition(s) in step S605 according to the second exemplary embodiment is/are not satisfied. While printing is terminated in a case where periodic printing defects are present on the in-apparatus remaining sheet according to the present exemplary embodiment, any method capable of determining a high probability of non-accidentality may be employed.

As presented above, the present exemplary embodiment inspects the in-apparatus remaining sheets following the defective sheet and changes the recovery printing operation depending on the inspection results on the in-apparatus remaining sheets. This makes it possible to provide an automatic recovery printing function for variable printing while reducing waste sheets in a case where printing defects that occur non-accidentally. Furthermore, the present exemplary embodiment prevents the occurrence of waste sheets by terminating printing in a case where it is determined that there is a significantly high probability that defective sheets will occur during recovery printing based on results of inspection performed on the in-apparatus remaining sheets.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure includes exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-003740, filed Jan. 15, 2024, which is hereby incorporated by reference herein in its entirety.

What is claimed is:

1. An inspecting apparatus comprising:
a receiving interface configured to receive a scanned image generated by scanning a printed material generated by forming an image on a sheet using an image forming apparatus; and
a controller configured to inspect the printed material based on the scanned image and a correct image registered in advance and instruct, in response to determining the printed material to be a defective sheet in the inspection performed on the printed material, the image forming apparatus to perform first recovery printing for reprinting starting from the image printed on the defective sheet,
wherein the controller inspects a subsequent sheet following the sheet determined to be a defective sheet through the inspection performed on the printed material, and
wherein, in a case where a result of the inspection performed on the subsequent sheet satisfies a predetermined condition, the controller issues an instruction to perform second recovery printing different from the first recovery printing.

2. The inspecting apparatus according to claim 1, wherein the predetermined condition is a first condition that a proportion of a plurality of the subsequent sheets that have been determined to be defective as the result of inspection performed on the plurality of the subsequent sheets is greater than or equal to a predetermined proportion.

3. The inspecting apparatus according to claim 1, wherein the predetermined condition is a second condition that the defective sheet and the subsequent sheet are consecutively determined to be defective for a predetermined number of times or more as the result of the inspection performed on the subsequent sheet.

4. The inspecting apparatus according to claim 1, wherein the predetermined condition is a third condition that, as the result of the inspection performed on the subsequent sheet, it is determined that a similar predetermined printing defect occurs for a predetermined number of times or more on the defective sheet and the subsequent sheet.

5. The inspecting apparatus according to claim 1, wherein the predetermined condition is a fourth condition that, as the result of the inspection performed on the subsequent sheet, it is determined that a periodic printing defect occurs on the defective sheet and the subsequent sheet.

6. The inspecting apparatus according to claim 1, wherein, in response to the controller determining that the printed material is the defective sheet through the inspection performed on the printed material, the controller transmits information for temporarily stopping printing to the image forming apparatus.

7. The inspecting apparatus according to claim 1,
wherein the image forming apparatus includes a plurality of sheet discharging trays,
wherein the inspecting apparatus further includes a transmitting interface configured to transmit, to the image forming apparatus, information for switching a sheet discharge destination for the printed material based on the result of the inspection performed on the printed material, and
wherein the transmitting interface transmits information for discharging the defective sheet and the subsequent sheet to a sheet discharging tray different from a sheet discharging tray for a deliverable.

8. The inspecting apparatus according to claim 7, wherein the transmitting interface transmits, based on the result of the inspection performed on the subsequent sheet, the information for not switching the sheet discharge destination for the printed material and for discharging the printed material to the sheet discharging tray different from the sheet discharging tray for the deliverable.

9. The inspecting apparatus according to claim 1, wherein, in a case where the predetermined condition is not satisfied, the controller instructs the image forming apparatus to perform the first recovery printing.

10. The inspecting apparatus according to claim 1, wherein the first recovery printing is a printing method for performing control so that recovery printing with a normal printing method of the image forming apparatus is performed.

11. The inspecting apparatus according to claim 1, wherein the second recovery printing is a printing method for performing control so that image formation by the image forming apparatus and inspecting of the printed material by the inspecting apparatus are performed on every specified number of sheets starting from an image printed on the defective sheet.

12. The inspecting apparatus according to claim 1, wherein the controller issues an instruction to switch to the first recovery printing in a case where no defect is determined for a predetermined number of times or more during the second recovery printing.

13. The inspecting apparatus according to claim 1, wherein the controller issues an instruction to stop image formation by the image forming apparatus in a case where a defect is determined for a predetermined number of times or more during the second recovery printing.

14. The inspecting apparatus according to claim 1, wherein the controller issues an instruction to stop image formation by the image forming apparatus in a case where occurrence of a periodic printing defect in the defective sheet and the subsequent sheet is determined as the result of the inspection performed on the subsequent sheet.

15. An inspecting system comprising:
an image forming apparatus configured to generate a printed material by forming an image on a sheet; and
an inspecting apparatus configured to generate a scanned image by scanning the printed material and inspect the printed material based on the scanned image and a correct image registered in advance,
wherein the inspecting apparatus includes a controller configured to instruct, in response to determining the printed material to be a defective sheet in the inspection performed on the printed material, the image forming apparatus to perform first recovery printing for reprinting starting from the image printed on the defective sheet,
wherein the controller inspects a subsequent sheet following the sheet determined to be a defective sheet through the inspection performed on the printed material, and
wherein, in a case where a result of the inspection performed on the subsequent sheet satisfies a predetermined condition, the controller issues an instruction to perform second recovery printing different from the first recovery printing.

16. The inspecting system according to claim 15, wherein the predetermined condition is a first condition that the proportion of a plurality of the subsequent sheets determined to be defective as the result of the inspection performed on the subsequent sheet is greater than or equal to a predetermined proportion.

17. The inspecting system according to claim 15, wherein the predetermined condition is a second condition that the defective sheet and the subsequent sheet are consecutively determined to be defective for a predetermined number of times or more as the result of the inspection performed on the subsequent sheet.

18. The inspecting system according to claim 15, wherein the predetermined condition is a third condition that, as the result of the inspection performed on the subsequent sheet, it is determined that a similar predetermined printing defect occurs for a predetermined number of times or more on the defective sheet and the subsequent sheet.

19. The inspecting system according to claim 15, wherein the predetermined condition is a fourth condition that, as the result of the inspection performed on the subsequent sheet, it is determined that a periodic printing defect occurs on the defective sheet and the subsequent sheet.

20. The inspecting system according to claim 15, wherein, in response to the controller determining that the printed material is the defective sheet through the inspection performed on the printed material, the controller transmits information for temporarily stopping printing to the image forming apparatus.

21. The inspecting system according to claim 15,
wherein the image forming apparatus includes a plurality of sheet discharging trays,
wherein the inspecting apparatus further includes a transmitting interface configured to transmit, to the image forming apparatus, information for switching a sheet discharge destination for the printed material based on the result of the inspection performed on the printed material, and
wherein the transmitting interface transmits information for discharging the defective sheet and the subsequent sheet to a sheet discharging tray different from a sheet discharging tray for a deliverable.
